(19) United States
(12) Patent Application Publication
(10) Pub. No.: US 2022/0166071 A1
(43) Pub. Date: May 26, 2022

(54) SECONDARY BATTERY

(71) Applicant: MURATA MANUFACTURING CO., LTD., Kyoto (JP)

(72) Inventor: Hidetoshi TAKAHASHI, Kyoto (JP)

(21) Appl. No.: 17/587,680

(22) Filed: Jan. 28, 2022

Related U.S. Application Data
(63) Continuation of application No. PCT/JP2020/027716, filed on Jul. 16, 2020.

(30) Foreign Application Priority Data
Jul. 31, 2019 (JP) 2019-141044

(51) Int. Cl. H01M 10/0587

(52) U.S. Cl. CPC H01M 10/0587

(57) ABSTRACT

Provided is a secondary battery including a wound electrode body in which a positive electrode and a negative electrode are wound with a separator interposed between the positive electrode and the negative electrode. In such a secondary battery, an electrode of the positive electrode and an electrode of the negative electrode each includes an electrode current collector and an electrode material layer provided on the electrode current collector in such a manner as to form an electrode current collector exposed portion where a part of the electrode current collector is exposed, in a sectional view of the wound electrode body, the negative electrode current collector exposed portion includes at least one first negative electrode current collector exposed portion facing the positive electrode material layer in the positive electrode that is adjacent on both sides in a thickness direction of the wound electrode body.

### CROSS REFERENCE TO RELATED APPLICATIONS

The present application is a continuation of PCT patent application no. PCT/JP2020/027716 filed on Jul. 16, 2020, which claims priority to Japanese patent application no. JP2019-141044 filed on Jul. 31, 2019, the entire contents of which are incorporated herein by reference.

### BACKGROUND

The present disclosure relates to a secondary battery. More specifically, the present disclosure relates to a wound secondary battery having a wound electrode body in which a positive electrode and a negative electrode are wound with a separator interposed between the positive electrode and the negative electrode.

Secondary batteries can be repeatedly charged and discharged because they are so-called rechargeable batteries and are used for various applications. For example, secondary batteries are used in mobile devices such as mobile phones, smartphones, and notebook computers.

A secondary battery commonly has a structure in which an electrode body is housed in an exterior body.

### SUMMARY

The present disclosure relates to a secondary battery.

Conventional secondary batteries have problems to be overcome.

A secondary battery commonly has a structure in which an electrode body including a positive electrode, a negative electrode, and a separator disposed between the positive electrode and the negative electrode, and an electrolyte are enclosed in an exterior body. In the electrode body in a wound secondary battery, a positive electrode and a negative electrode are wound with a separator interposed between the positive electrode and the negative electrode.

In such a wound secondary battery, a structure for preventing a short circuit between a positive electrode and a negative electrode due to deterioration over time, external impact, and the like has been proposed.

As shown in FIG. 10, for example, from the viewpoint of handling at the time of manufacturing a battery, in an inner peripheral portion of a wound electrode body 100, a positive electrode 1 and a negative electrode 2 respectively include a positive electrode current collector exposed portion 11E and a negative electrode current collector exposed portion 21E where a positive electrode material layer 12 or a negative electrode material layer 22 is not provided at their end portions.

The positive electrode current collector exposed portion 11E and the negative electrode current collector exposed portion 21E are close to each other, and an insulating member 5 is provided between the exposed portions. The insulating member 5 can prevent a short circuit due to contact between the positive electrode current collector exposed portion and the negative electrode current collector exposed portion. That is, it is possible to prevent a low-resistance short circuit due to contact between electrode current collectors of different polarities.

In the secondary battery having such a configuration, there is a possibility that a medium-resistance short circuit occurs due to contact between the electrode current collector (for example, the negative electrode current collector exposed portion 21E) and an electrode material layer (for example, the positive electrode material layer 12) having a polarity different from the polarity of the electrode current collector, after a low-resistance short circuit. When such a medium-resistance short circuit occurs, the calorific value becomes larger than that of a low-resistance short circuit, and the risk of ignition becomes higher.

The present technology has been developed in view of such a problem. According to an embodiment, the present technology is directed to provide a secondary battery more suitable in terms of prevention of a short circuit, particularly prevention of a medium-resistance short circuit.

The present disclosure, according to an embodiment, relates to a secondary battery including a wound electrode body in which a positive electrode and a negative electrode are wound with a separator interposed between the positive electrode and the negative electrode, wherein the positive electrode includes a positive electrode current collector and a positive electrode material layer provided on the positive electrode current collector in such a manner as to form a positive electrode current collector exposed portion where a part of the positive electrode current collector is exposed, and the negative electrode includes a negative electrode current collector and a negative electrode material layer provided on the negative electrode current collector in such a manner as to form a negative electrode current collector exposed portion where a part of the negative electrode current collector is exposed,

in a sectional view of the wound electrode body, the negative electrode current collector exposed portion includes at least one first negative electrode current collector exposed portion facing the positive electrode material layer in the positive electrode that is most adjacent on both sides in a thickness direction of the wound electrode body, an insulating member is provided in such a manner as to cover the first negative electrode current collector exposed portion, and the insulating member has a breaking elongation relatively larger than a breaking elongation of the negative electrode current collector.

The secondary battery according to an embodiment of the present application has a more suitable structure in terms of prevention of a short circuit, particularly prevention of a medium-resistance short circuit.

More specifically, for example, in the wound electrode body (in particular, the inner peripheral portion of the wound electrode body) of the secondary battery according to an embodiment, an insulating member is provided in such a manner as to cover the negative electrode current collector exposed portion facing the positive electrode material layer of the positive electrode that is most adjacent on both sides in the thickness direction of the wound electrode body. The breaking elongation of the insulating member is larger than the breaking elongation of the negative electrode current collector. Therefore, when an impact or the like is applied to the secondary battery from the outside, it is possible to prevent the negative electrode current collector exposed portion and the positive electrode material layer from coming into contact with each other. Therefore, it is possible to prevent more suitably a medium-resistance short circuit in the electrode body.

### BRIEF DESCRIPTION OF THE FIGURES

FIG. 1 is a schematic sectional view of a wound secondary battery according to an embodiment of the present disclosure.

FIG. 2 is a schematic sectional view of an embodiment in which an insulating member is provided in such a manner as to cover a double-sided negative electrode current collector exposed portion of a first negative electrode current collector exposed portion in an inner peripheral portion of a wound electrode body of a secondary battery.

FIG. 3 is a schematic sectional view of an embodiment in which a double-sided negative electrode current collector exposed portion is different in form in the secondary battery shown in FIG. 2.

FIG. 4 is a schematic sectional view of an embodiment in which an insulating member is provided in such a manner as to cover a single-sided negative electrode current collector exposed portion of a first negative electrode current collector exposed portion in an inner peripheral portion of a wound electrode body of a secondary battery.

FIG. 5 is a schematic sectional view of an embodiment in which an insulating member is provided in such a manner as to cover a double-sided negative electrode current collector exposed portion and a single-sided negative electrode current collector exposed portion in an inner peripheral portion of a wound electrode body of a secondary battery.

FIG. 6 is a schematic sectional view of an embodiment in which first negative electrode current collector exposed portions adhere to each other by an insulating member in an inner peripheral portion of a wound electrode body of a secondary battery.

FIGS. 7A and 7B are schematic plan views for explaining constituent members of an electrode body included in a secondary battery according to an embodiment of the present disclosure.

FIG. 8 is a schematic perspective view for explaining a method of assembling a wound electrode body included in a secondary battery according to an embodiment of the present disclosure.

FIG. 9 is a schematic perspective developed view of a secondary battery according to an embodiment of the present disclosure.

FIG. 10 is a schematic sectional view of an inner peripheral portion of a secondary battery according to a conventional technique.

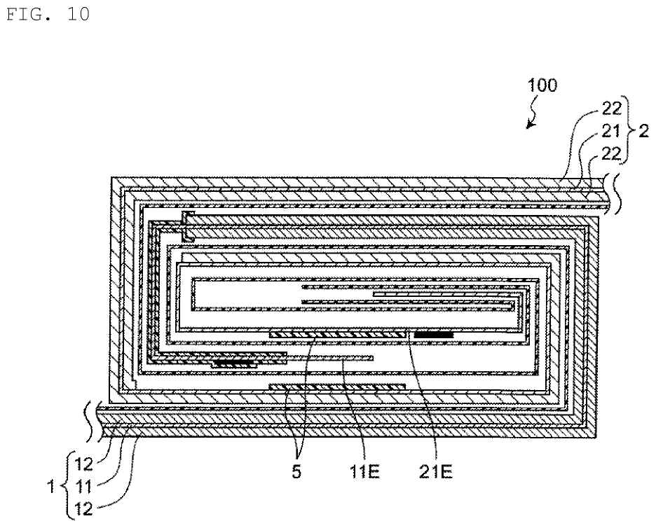

### DETAILED DESCRIPTION

As described herein, a secondary battery according to an embodiment of the present technology will be described in more detail. While the description will be made with reference to the drawings as necessary, various elements in the drawings are schematically and exemplarily shown for an understanding of the present technology, according to an embodiment, where the appearance, the dimensional ratio, and the like may be different from as shown.

“Thickness direction” described directly or indirectly in the present specification is based on a direction in which two main faces of a wound electrode body (or a secondary battery) face each other (that is, the normal direction of the main faces). Here, “main face” may correspond to a face of the wound electrode body to be pressed in a manufacturing process of the secondary battery (that is, the face in which the pressing direction when a pressing process is performed is the normal direction).

For example, in the case of a “secondary battery having a thickness in a plate shape” such as a flat battery, “thickness direction” corresponds to the plate thickness direction of the secondary battery. In other words, “thickness direction” is based on a direction parallel to a face having the smallest dimension among faces of the secondary battery.

“Width direction” described directly or indirectly in the present specification is based on a direction substantially orthogonal to the winding axis direction (that is, in the longitudinal direction,) and the thickness direction in the wound electrode body.

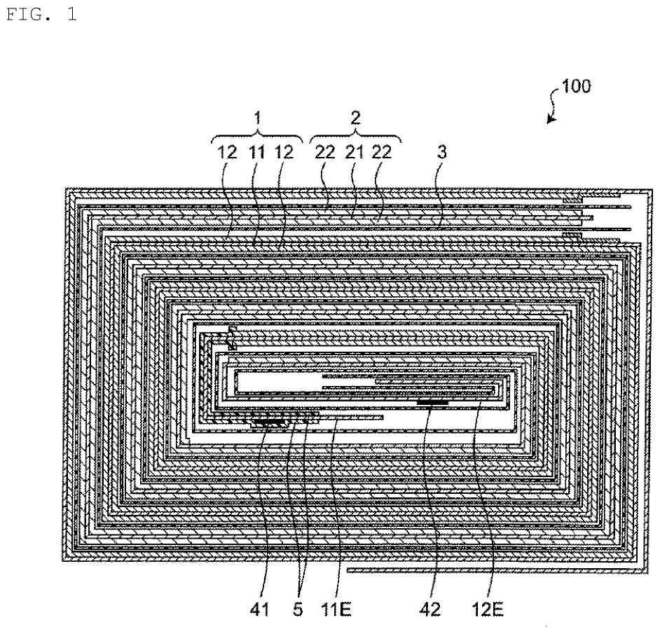

“Sectional view” in the present specification is based on a form in a case where an object (for example, a wound electrode body) is captured along a direction substantially perpendicular to the thickness direction and the width direction. In other words, it is based on the form of the section formed by the thickness direction and the width direction. In short, “sectional view” corresponds to a virtual section in which the winding state can be grasped as shown in FIG. 1 and the like.

In the present specification, “inner peripheral portion” refers to a portion close to the electrode end portion located in the vicinity of the center of the wound electrode body out of the end portions of in the electrode longitudinal direction. That is, when the electrode is developed in an unwound state, the end portions can be regarded as the end portions of the long electrode, and a portion in the vicinity of an end portion located in the vicinity of the winding center of the wound electrode body corresponds to the inner peripheral portion. In short, the inner peripheral portion corresponds to a region of a winding start portion in the wound electrode body. For example, a portion surrounded by “the negative electrode in which a negative electrode material layer is provided on both faces of the negative electrode current collector” located on the innermost side of the wound electrode body may be regarded as the inner peripheral portion.

In the present specification, “outer peripheral portion” refers to a portion close to the electrode end portion located in the vicinity of the outermost surface of the wound electrode body out of the end portions in the electrode longitudinal direction. That is, when the electrode is developed in an unwound state, the end portions can be regarded as the end portions of the long electrode, and a portion in the vicinity of the other end portion located on the wound outer side of the wound electrode body corresponds to the outer peripheral portion. In short, the outer peripheral portion corresponds to a region of a winding end portion in the wound electrode body. For example, the positive electrode and the negative electrode located on the outermost side of the wound electrode body may be regarded as the outer peripheral portion.

The present disclosure provides a secondary battery. In the present specification, the term “secondary battery” refers to a battery that can be repeatedly charged and discharged. “Secondary battery” is not excessively limited by its name, and may encompass, for example, an electrochemical device such as a “power storage device”.

The secondary battery according to an embodiment includes a wound electrode body in which a positive electrode and a negative electrode are wound with a separator interposed between the positive electrode and the negative electrode. FIG. 1 shows a wound electrode body 100 as an example. In the wound electrode body 100, a positive electrode 1 and a negative electrode 2 are stacked with a separator 3 interposed between the positive electrode and the negative electrode to form an electrode constituent unit, and at least two or more such electrode constituent units are stacked in the thickness direction. In the secondary battery, such a wound electrode body 100 is enclosed in an exterior body together with an electrolyte (for example, a nonaqueous electrolyte).

The positive electrode includes at least a positive electrode material layer and a positive electrode current collector. More specifically, the positive electrode includes a positive electrode current collector and a positive electrode material layer provided on the positive electrode current collector such that a part of the positive electrode current collector is exposed. The positive electrode material layer contains a positive electrode active material as an electrode active material. The positive electrode current collector may have a foil form. That is, the positive electrode current collector may be formed of a metal foil.

For example, the positive electrode in the wound electrode body may be an electrode in which the positive electrode material layer is provided on both faces of the positive electrode current collector. The positive electrode may also be an electrode in which the positive electrode material layer is provided only on one face of the positive electrode current collector. In the positive electrode used for the wound electrode body, the positive electrode current collector may have a part where the positive electrode material layer is not provided.

The negative electrode includes at least a negative electrode material layer and a negative electrode current collector. More specifically, the negative electrode includes a negative electrode current collector and a negative electrode material layer provided on the negative electrode current collector such that a part of the negative electrode current collector is exposed. The negative electrode material layer contains a negative electrode active material as an electrode active material. The negative electrode current collector may have a foil form. That is, the negative electrode current collector may be formed of a metal foil.

For example, the negative electrode in the wound electrode body may be an electrode in which the negative electrode material layer is provided on both faces of the negative electrode current collector. The negative electrode may be an electrode in which the negative electrode material layer is provided only on one face of the negative electrode current collector. In the negative electrode used for the wound electrode body, the negative electrode current collector may have a part where the negative electrode material layer is not provided.

In the exemplary embodiment shown in FIG. 1, according to an embodiment, from the viewpoint of handling at the time of manufacture, in the inner peripheral portion of the wound electrode body 100, the positive electrode 1 and the negative electrode 2 respectively include the positive electrode current collector exposed portion 11E and the negative electrode current collector exposed portion 21E where the positive electrode material layer 12 or the negative electrode material layer 22 are not provided at their end portions. Here, the inner peripheral portion of the wound electrode body 100 corresponds to a portion surrounded by “the negative electrode 2 in which the negative electrode material layer 22 is provided on both faces of the negative electrode current collector 21” located on the innermost side of the wound electrode body 100.

In a portion other than the inner peripheral portion and the outer peripheral portion of the wound electrode body 100, the positive electrode 1 has a positive electrode material layer 12 on both faces of the positive electrode current collector 11, and the negative electrode 2 has a negative electrode material layer 22 on both faces of the negative electrode current collector 21. With such a configuration, it is possible to increase the capacity of the secondary battery.

The electrode active materials contained in the positive electrode and the negative electrode, that is, the positive electrode active material and the negative electrode active material are substances directly involved in the transfer of electrons in the secondary battery and are main substances of the positive and negative electrodes responsible for charge and discharge, that is, a battery reaction.

More specifically, ions are brought into the electrolyte due to “the positive electrode active material contained in the positive electrode material layer” and “the negative electrode active material contained in the negative electrode material layer”. Such ions move between the positive electrode and the negative electrode to transfer electrons, and charge and discharge are performed.

The positive electrode material layer and the negative electrode material layer may be layers particularly capable of occluding and releasing lithium ions. That is, the secondary battery may be a nonaqueous electrolyte secondary battery in which lithium ions move between the positive electrode and the negative electrode with the nonaqueous electrolyte interposed therebetween to charge and discharge the battery.

When lithium ions are involved in charge and discharge, the secondary battery according to the present disclosure corresponds to a so-called “lithium ion battery”. In a lithium ion battery, a positive electrode and a negative electrode include a layer capable of occluding and releasing lithium ions.

The positive electrode active material of the positive electrode material layer includes, for example, a granular material, and a binder may be contained in the positive electrode material layer for more sufficient contact between grains and shape retention. Furthermore, a conductive assistant may be contained in the positive electrode material layer to facilitate transfer of electrons promoting the battery reaction.

Likewise, the negative electrode active material of the negative electrode material layer includes, for example, a granular material, and a binder may be contained in the negative electrode material layer for sufficient contact between grains and shape retention, and a conductive assistant may be contained in the negative electrode material layer to facilitate transfer of electrons promoting the battery reaction.

As described above, because a plurality of components are contained, the positive electrode material layer and the negative electrode material layer may also be referred to as “positive electrode mixture layer” and “negative electrode mixture layer”, respectively.

The positive electrode active material may be a material that contributes to occlusion and release of lithium ions. From such a viewpoint, the positive electrode active material may be, for example, a lithium-containing composite oxide. More specifically, the positive electrode active material may be a lithium transition metal composite oxide containing lithium and at least one transition metal selected from the group consisting of cobalt, nickel, manganese, and iron.

That is, in the positive electrode material layer of the secondary battery according to the present embodiment, such a lithium transition metal composite oxide is preferably contained as the positive electrode active material. For example, the positive electrode active material may be lithium cobalt oxide, lithium nickel oxide, lithium manganese oxide, lithium iron phosphate, or a material obtained by replacing a part of these transition metals with another metal.

The positive electrode active material as described above may be contained as a single species, or two or more species may be contained in combination.

The binder that may be contained in the positive electrode material layer is not particularly limited, and examples thereof include at least one selected from the group consisting of polyvinylidene fluoride, vinylidene fluoride-hexafluoropropylene copolymer, vinylidene fluoride-tetrafluoroethylene copolymer, polytetrafluoroethylene, and the like.

The conductive assistant that may be contained in the positive electrode material layer is not particularly limited, and examples thereof include at least one selected from carbon blacks such as thermal black, furnace black, channel black, Ketjen black, and acetylene black, carbon fibers such as graphite, carbon nanotube, and vapor-grown carbon fiber, metal powders such as copper, nickel, aluminum, and silver, polyphenylene derivatives, and the like.

The thickness of the positive electrode material layer is not particularly limited and may be 1 μm or more and 100 μm or less, and is, for example, 5 μm or more and 20 μm or less. The thickness of the positive electrode material layer is the thickness inside the secondary battery, and an average value of measured values at any 10 points is adopted.

The negative electrode active material may be a material that contributes to occlusion and release of lithium ions. From such a viewpoint, the negative electrode active material may be, for example, various carbon materials, oxides, lithium alloys, or the like.

Examples of the various carbon materials the negative electrode active material include graphite (natural graphite and/or artificial graphite), hard carbon, soft carbon, and diamond-like carbon.

Examples of the oxide of the negative electrode active material include at least one selected from the group consisting of silicon oxide, tin oxide, indium oxide, zinc oxide, lithium oxide, and the like.

The lithium alloy of the negative electrode active material may be any metal that may be alloyed with lithium, and examples thereof include a binary, ternary, or higher alloy of lithium and a metal such as Al, Si, Pb, Sn, In, Bi, Ag, Ba, Ca, Hg, Pd, Pt, Te, Zn, or La. Such an oxide may be amorphous as its structural form. This is because deterioration due to nonuniformity such as crystal grain boundaries or defects is less likely to occur.

The binder that may be contained in the negative electrode material layer is not particularly limited, and examples thereof include at least one selected from the group consisting of styrene butadiene rubber, polyacrylic acid, polyvinylidene fluoride, a polyimide resin, and a polyamideimide resin.

The conductive assistant that may be contained in the negative electrode material layer is not particularly limited, and examples thereof include at least one selected from carbon blacks such as thermal black, furnace black, channel black, Ketjen black, and acetylene black, carbon fibers such as graphite, carbon nanotube, and vapor-grown carbon fiber, metal powders such as copper, nickel, aluminum, and silver, polyphenylene derivatives, and the like. The negative electrode material layer may contain a component derived from a thickener component used at the time of manufacturing the battery.

The thickness of the negative electrode material layer is not particularly limited and may be 1 μm or more and 100 μm or less, and is, for example, 10 μm or more and 70 μm or less. The thickness of the negative electrode material layer is the thickness inside the secondary battery, and an average value of measured values at any 10 points is adopted.

The positive electrode current collector used for the positive electrode and the negative electrode current collector used for the negative electrode are members that contribute to collecting and supplying electrons generated in the active materials due to the battery reaction. Such a current collector may be a sheet-like metal member or may have a porous or perforated form. For example, the current collector may be a metal foil, a punching metal, a net, an expanded metal, or the like.

The positive electrode current collector used for the positive electrode may include a metal foil containing at least one selected from the group consisting of aluminum, stainless steel, nickel, and the like.

The negative electrode current collector used for the negative electrode may include a metal foil containing at least one selected from the group consisting of copper, stainless steel, nickel, and the like.

The thickness of the positive electrode current collector and the negative electrode current collector is not particularly limited and may be 1 μm or more and 100 μm or less, and is, for example, 10 μm or more and 70 μm or less. The thickness of the positive electrode current collector and the negative electrode current collector is the thickness inside the secondary battery, and an average value of measured values at any 10 points is adopted.

The separator is a member provided from the viewpoint of preventing a short circuit due to contact between the positive and negative electrodes, holding the electrolyte, and the like. In other words, it can be said that the separator is a member that allows ions to pass while preventing electronic contact between the positive electrode and the negative electrode.

For example, the separator is a porous or microporous insulating member, and has a membrane form due to its small thickness. Although it is merely an example, a microporous membrane formed of polyolefin may be used as the separator.

The microporous membrane used as the separator may contain, for example, only polyethylene (PE) or only polypropylene (PP) as polyolefin. Furthermore, the separator may be a laminate composed of “a microporous membrane made of PE” and “a microporous membrane made of PP”. The surface of the separator may be covered with an inorganic grain coating layer and/or an adhesive layer. The surface of the separator may have adhesiveness.

The thickness of the separator is not particularly limited and may be 1 μm or more and 100 μm or less, and is, for example, 2 μm or more and 20 μm or less. The thickness of the separator is the thickness inside the secondary battery (in particular, the thickness between the positive electrode and the negative electrode), and an average value of measured values at any 10 points is adopted.

In the secondary battery according to the present invention, the electrode body including the positive electrode, the negative electrode, and the separator is enclosed in an exterior body together with an electrolyte. The electrolyte assists movement of metal ions released from the electrodes (positive electrode and negative electrode). The electrolyte may be a “nonaqueous” electrolyte, such as an organic electrolyte or an organic solvent, or an “aqueous” electrolyte containing water.

The secondary battery according to the present disclosure is, for example, a nonaqueous electrolyte secondary battery using an electrolyte containing a “nonaqueous” solvent and a solute as an electrolyte. The electrolyte may have a form such as a liquid form or a gel form.

As a specific solvent of the nonaqueous electrolyte, a solvent containing at least a carbonate may be used. Such a carbonate may be a cyclic carbonate and/or a chain carbonate.

Although not particularly limited, examples of the cyclic carbonate include at least one selected from the group consisting of propylene carbonate (PC), ethylene carbonate (EC), butylene carbonate (BC), and vinylene carbonate (VC).

Examples of the chain carbonate include at least one selected from the group consisting of dimethyl carbonate (DMC), diethyl carbonate (DEC), ethyl methyl carbonate (EMC), and dipropyl carbonate (DPC).

In one preferred embodiment of the present disclosure, a combination of a cyclic carbonate and a chain carbonate is used as the nonaqueous electrolyte, and for example, a mixture of ethylene carbonate and diethyl carbonate is used. Specific examples of the solute of the nonaqueous electrolyte include Li salts such as LiPF₆ and LiBF₄.

A current collecting tab may be provided at any position in the electrode. For example, the current collecting tab may be provided in an electrode portion positioned in the inner peripheral portion of the wound electrode body, may be provided in an electrode portion positioned in the outer peripheral portion of the wound electrode body, and/or may be provided in an electrode portion positioned other than the inner peripheral portion and the outer peripheral portion.

In the exemplary embodiment shown in FIG. 1, according to an embodiment, in the inner peripheral portion of the wound electrode body 100, the positive electrode current collecting tab 41 and the negative electrode current collecting tab 42 are respectively provided on the positive electrode current collector exposed portion 11E and the negative electrode current collector exposed portion 21E. With such a configuration, each current collecting tab can be provided without separately exposing the electrode current collector, and the process can be simplified.

As the current collecting tab, any current collecting tab used in the field of secondary batteries may be used. The current collecting tab may be made of a material capable of achieving electron movement. For example, the current collecting tab includes a conductive material such as silver, gold, copper, iron, tin, platinum, aluminum, nickel, and/or stainless steel.

The form of the current collecting tab is not particularly limited, and may be, for example, a linear shape or a plate shape. The current collecting tab may be provided integrally with the electrode current collector of the electrode or may be provided on the electrode current collector as a different member from the electrode current collector. In the positive electrode and the negative electrode, at least one positive electrode current collecting tab and at least one negative electrode current collecting tab may be provided. Alternatively, a plurality of current collecting tabs may be provided for each of the positive electrode and the negative electrode.

The insulating member may be provided at any position in the wound electrode body. For example, in the inner peripheral portion of the wound electrode body, the insulating member may be provided on a part or the whole of the facing portions of the positive electrode current collector exposed portion and the negative electrode current collector exposed portion.

In the exemplary embodiment shown in FIG. 1, according to an embodiment, the insulating member 5 is provided on a part of the positive electrode current collector exposed portion 11E in the inner peripheral portion of the wound electrode body 100. Such a configuration can preferably prevent an internal short circuit.

The insulating member may include a film substrate and a pressure-sensitive adhesive layer formed on one face of the film substrate, and a non-conductive film may be formed on the other face of the substrate. In other words, the insulating member may be in the form of a tape. Alternatively, the insulating member may be a pressure-sensitive adhesive layer formed by coating a place where the insulating member is to be provided. Such a pressure-sensitive adhesive layer may be an adhesive layer.

When the insulating member is in the form of a tape, the pressure-sensitive adhesive layer may be provided only on one face of the film substrate, and the pressure-sensitive adhesive layer may also be provided on a face opposite to the film substrate in the non-conductive film formed on both faces of the film substrate. Preferably, the insulating member has the pressure-sensitive adhesive layer only on one face of the film substrate.

The film substrate is not particularly limited as long as it is a non-conductive resin substrate. Examples of the film substrate include polyimide, polyethylene, polyethylene terephthalate, and/or polyfluoroethylene. The thickness of the film substrate may be 1 μm or more and 90 μm or less, and is, for example, 5 μm or more and 40 μm or less.

The pressure-sensitive adhesive layer is not particularly limited as long as it is a non-conductive pressure-sensitive adhesive layer used as a pressure-sensitive adhesive layer of a common insulating tape. Examples of the pressure-sensitive adhesive layer include a silicon resin layer (for example, a silicon polymer layer) and/or an acrylic resin layer (for example, an acrylic polymer layer). The thickness of the pressure-sensitive adhesive layer may be 1 μm or more and 50 μm or less, and is, for example, 1 μm or more and 20 μm or less.

The pressure-sensitive adhesive layer in the insulating member may stick only to any place to be formed.

Alternatively, the layer may be formed in such a manner to stick to a constituent member adjacent to the layer or to stick adjacent constituent members adjacent to each other.

The total thickness of the film substrate and the pressure-sensitive adhesive layer is not particularly limited and may be 2 μm or more and 140 μm or less, and is, for example, 6 μm or more and 60 μm or less.

The non-conductive film may be formed of a non-conductive inorganic material from the viewpoint of water vapor barrier properties. The non-conductive inorganic material is not particularly limited, and examples thereof include one or more non-conductive inorganic materials selected from the group consisting of metal oxides, metal nitrides, clays, and diamond-like carbon (DLC). Specific examples of the metal oxide include silicon dioxide (SiO₂). Specific examples of the metal nitride include silicon nitride (Si₃N₄) and/or (aluminum nitride) (ALN). Specific examples of the clay include montmorillonite (for example, lithium-substituted montmorillonite). A clay film is an inexpensive and flexible water vapor barrier film.

The exterior body may be a hard case or a flexible case. When the exterior body is a hard case, the exterior body has, for example, a two-part configuration of a first exterior body and a second exterior body. The exterior body having the two-part configuration may include a main body portion and a lid portion. In such a case, the main body portion and the lid portion may be sealed to each other after housing the electrode body, the electrolyte, the current collecting tabs, and an electrode terminal as desired. The sealing method is not particularly limited, and examples thereof include a laser irradiation method.

As a material constituting the main body portion and the lid portion of the exterior body, any material that can constitute a hard case type exterior body in the field of secondary batteries may be used. Such a material may be a conductive material in which electron transfer can be achieved or may be an insulating material in which electron transfer cannot be achieved. The material of the exterior body is preferably a conductive material from the viewpoint of taking out the electrode.

Examples of the conductive material of the exterior body include a metal material selected from the group consisting of silver, gold, copper, iron, tin, platinum, aluminum, nickel, stainless steel, and the like. Examples of the insulating material include an insulating polymer material selected from the group consisting of polyester (for example, polyethylene terephthalate), polyimide, polyamide, polyamideimide, polyolefin (for example, polyethylene or polypropylene), and the like.

The dimensions of the main body portion and the lid portion of the exterior body are determined mainly according to the dimensions of the electrode body. For example, it is preferable that the exterior body has such dimensions that movement of the electrode body in the exterior body is prevented when the electrode body is housed. By preventing the movement of the electrode body, it is possible to prevent the damage of the electrode body due to an impact or the like and to improve the safety of the secondary battery.

When the exterior body is a flexible case, the flexible case may be in the form of a pouch or the like made of a laminate film. The laminate film may have a configuration in which at least a metal layer (for example, aluminum or the like) and an adhesive layer (for example, polypropylene and/or polyethylene, etc.) are laminated, or a configuration in which a protective layer (for example, nylon and/or polyamide, etc.) is additionally laminated.

The thickness of the exterior body is not particularly limited and may be 10 μm or more and 200 μm or less, and is, for example, 50 μm or more and 100 μm or less. As the thickness of the exterior body, an average value of measured values at any 10 points is adopted.

The positive electrode current collecting tab and the negative electrode current collecting tab may be led out to the outside through openings (or gaps) formed in the exterior body. Alternatively, the positive electrode current collecting tab and the negative electrode current collecting tab may be electrically connected to an electrode terminal provided on the exterior body and may be led out to the outside through the electrode terminal.

As the electrode terminal, a material having high conductivity is preferably used. The material of the electrode terminal is not particularly limited and may be at least one selected from the group consisting of silver, gold, copper, iron, tin, platinum, aluminum, nickel, and stainless steel.

The secondary battery according to an embodiment of the present disclosure is a battery having a wound electrode body in which a positive electrode and a negative electrode are wound with a separator interposed between the positive electrode and the negative electrode and has at least a feature in terms of an installation range and breaking elongation of an insulating member provided in the wound electrode body.

Specifically, in a sectional view of the wound electrode body, the negative electrode current collector exposed portion includes the first negative electrode current collector exposed portion facing the positive electrode material layer in the positive electrode that is most adjacent on both sides in the thickness direction of the wound electrode body. That is, the insulating member is provided on the negative electrode current collector exposed portion positioned between the most adjacent positive electrode material layers facing the negative electrode current collector in the wound electrode body. In particular, in the inner peripheral portion of the wound electrode body, the insulating member is provided on at least a part of the negative electrode current collector portion which is positioned between the most adjacent positive electrode material layers facing negative electrode current collector exposed portion and not provided with the negative electrode material layer.

Saying from another angle, the negative electrode current collector exposed portion can be regarded as end portions of a long negative electrode when the negative electrode is developed in an unwound state, and the negative electrode current collector exposed portion at one of the end portions located in the vicinity of the winding center of the wound electrode body includes an insulating member, and in particular, the negative electrode current collector exposed portion disposed in a region sandwiched by the positive electrode material layer includes an insulating member that covers at least a part of the current collector exposed portion.

In the present specification, the term “an insulating member is provided in such a manner as to cover the first negative electrode current collector exposed portion” broadly means that the insulating member is present on at least one of the exposed faces forming the first negative electrode current collector exposed portion in a sectional view of the wound electrode body. Preferably, the term refers to a continuous presence of the insulating member in such a manner as to span the folded or turned-back exposed face that is folded or turned-back due to the winding.

For example, “the insulating member is provided in such a manner as to cover the first negative electrode current collector exposed portion” means that the insulating member is provided on 30% or more of the surface area of the first negative electrode current collector exposed portion in the wound electrode body. In other words, it means that the coverage of the first negative electrode current collector exposed portion with the insulating member is 30% or more.

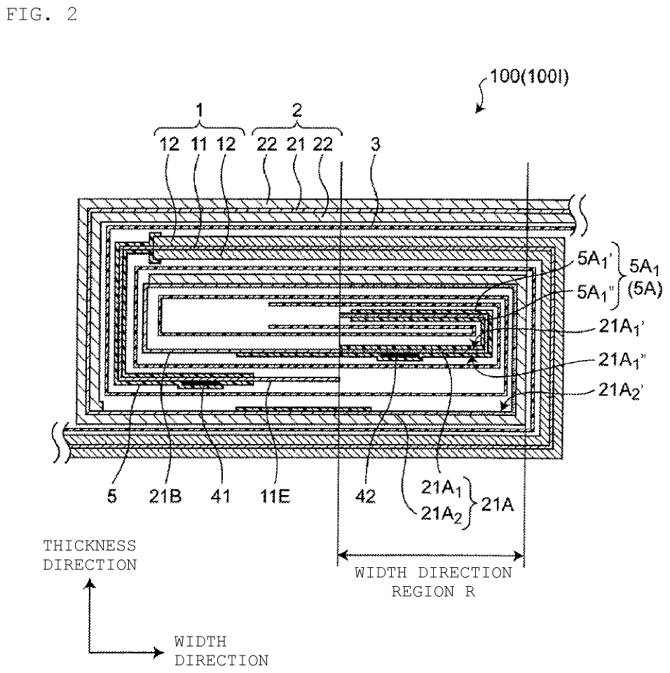

In the exemplary embodiment shown in FIG. 2, according to an embodiment, in a sectional view of the wound electrode body 100 (more specifically, an inner peripheral portion 1001 of the wound electrode body), the negative electrode current collector exposed portion includes the first negative electrode current collector exposed portion 21A facing the positive electrode material layer 12 of the positive electrode 1 that is most adjacent on both sides in the thickness direction of the wound electrode body 100, and the insulating member 5A is provided in such a manner as to cover the first negative electrode current collector exposed portion 21A. That is, the insulating member 5A is provided in such a manner as to cover the negative electrode current collector exposed portion 21A disposed inside the positive electrode material layer 12 wound on the innermost side in the wound electrode body. In other words, in a sectional view of the inner peripheral portion 1001 of the wound electrode body, the insulating member 5A is provided in such a manner as to cover the first negative electrode current collector exposed portion 21A positioned in a width direction region R where the positive electrode current collector exposed portion 11E is not present. This will be described in detail using the sectional view shown in FIG. 2. The positive electrode material layer is not present at the winding start portion of the positive electrode, and the positive electrode current collector exposed portion 11E where the positive electrode current collector is exposed in some part may be present. When the wound electrode body is divided into the side where the positive electrode current collector exposed portion is present and the side where the positive electrode current collector exposed portion is not present in the width direction of the wound electrode body with the outermost edge of the positive electrode current collector exposed portion 11E as a base point, a region where the positive electrode current collector exposed portion 11E is not present is the width direction region R. Therefore, in the negative electrode current collector exposed portion corresponding to the winding start portion, a portion present in the width direction region R corresponds to the first negative electrode current collector exposed portion 21A, and a portion present in other regions corresponds to the second negative electrode current collector exposed portion 21B. In a form of the sectional view shown in FIG. 2, it can also be understood that a region located in the width direction of the wound electrode body, which is the direction in which the negative electrode current collector first extends from the outermost edge of the negative electrode forming the winding center portion of the negative electrode as a base point corresponds to the “width direction region R”.

In the above-described embodiment, the insulating members 5A₁′ and 5A₁″ are continuously present on all sides (that is, on three sides separated by the bends at 21A₁′ and 21A₁″) of 21A₁′ and 21A₁″, respectively, among the exposed faces (that is, 21A₁¹, 21A₁″ and 21A₂′) forming the first negative electrode current collector exposed portion 21A.

As described above, because the insulating member 5A is provided in such a manner as to cover the first negative electrode current collector exposed portion 21A, the first negative electrode current collector exposed portion 21A and the positive electrode material layer 12 can be prevented from coming into contact with each other when an impact or the like is applied to the secondary battery from the outside. As a result, a medium-resistance short circuit in the wound electrode body 100 can be preferably prevented.

The insulating member 5A provided on the first negative electrode current collector exposed portion 21A has a breaking elongation relatively larger than a breaking elongation of the negative electrode current collector 21. That is, when the breaking elongation of the negative electrode current collector exposed portion 21A is compared with the breaking elongation of the insulating member 5A, the breaking elongation of the insulating member 5A is larger. With the insulating member 5A having a relatively large breaking elongation, the negative electrode current collector is difficult to break by an external impact. Even if the negative electrode current collector is broken, the broken negative electrode current collector can be prevented from being exposed from the portion covered with the insulating member. Therefore, a medium-resistance short circuit in the wound electrode body 100 can be more suitably prevented.

In the present specification, “the insulating member has a relatively larger breaking elongation than that of the negative electrode current collector” means that the ratio of the breaking elongation of the insulating member to the breaking elongation of the negative electrode current collector is 2 or more.

In one embodiment, the ratio of the breaking elongation of the insulating member to the breaking elongation of the negative electrode current collector is 10 or more, for example, 20 or more. When the breaking elongation ratio is 10 or more, breaking of the negative electrode current collector is particularly easily prevented, or when breaking occurs, the broken negative electrode current collector is easily prevented from being exposed. The upper limit of the ratio of the breaking elongation of the insulating member to the breaking elongation of the negative electrode current collector is not particularly limited, and may be, for example, 80, 70, 60, 50, 40, or 30.

Here, the breaking elongation of the insulating member may be 50% or more, and is preferably 100% or more, for example. This makes it particularly easy to prevent breakage of the negative electrode current collector, or when the negative electrode current collector is broken, it is easy to prevent the broken negative electrode current collector from being exposed. The upper limit of the breaking elongation of the insulating member is not particularly limited, and may be, for example, 400%, 300%, 200%, or 150%.

The breaking elongation of the insulating member is a value measured by a method conforming to JIS standard (JIS C 2151). For the measurement of the breaking elongation of the insulating member, a TENSILON universal tester (manufactured by A&D Company, Limited/model number RTF2410) may be used.

When the insulating member is in the form of a tape, the sample may be cut into a predetermined shape to measure the breaking elongation. When the insulating member has a form composed only of a pressure-sensitive adhesive layer (or adhesive layer), the breaking elongation may be measured by molding (for example, coating formation) the insulating member into a predetermined shape.

Because the insulating member is provided in the secondary battery, the insulating member taken out (for example, peeled off) from the secondary battery may be measured.

The breaking elongation of the electrode current collector is a value measured by a method conforming to JIS standard (JIS Z 2241). For the measurement of the breaking elongation of the electrode current collector, a TENSILON universal tester (manufactured by A&D Company, Limited/model number RTF2410) may be used.

As one embodiment, in the first negative electrode current collector exposed portion 21A, the insulating member 5 may be continuously provided in such a manner as to span at least the folded exposed face or the turned-back exposed face which is folded or turned-back due to the winding. That is, the insulating member 5 may have a form of being folded or turned-back in a sectional view in such a manner as to follow the exposed face. It can be said that, in a sectional view, the insulating member 5 has a folded or turned-back continuous form in such a manner as to cover the folded or turned-back first negative electrode current collector exposed portion 21A. For example, in the sectional view of FIG. 2, the insulating member 5 is integrally folded or turned back in such a manner as to cover the exposed face (for example, both faces thereof) of the folded or turned-back first negative electrode current collector exposed portion 21A in such a manner as to sandwich the separator therebetween. In such an embodiment, the effect of preventing a medium-resistance short circuit in the wound electrode body can be more remarkable.

In one embodiment, the first negative electrode current collector exposed portion 21A includes a double-sided negative electrode current collector exposed portion 21A₁ in which both faces of the negative electrode current collector 21 are exposed, and a single-sided negative electrode current collector exposed portion 21A₂ in which only one face of the negative electrode current collector 21 is exposed. Here, the insulating member 5A is provided on the double-sided negative electrode current collector exposed portion 21A₁ and/or the single-sided negative electrode current collector exposed portion 21A₂ (see FIG. 2).

The double-sided negative electrode current collector exposed portion 21A₁, which is less restrained from other constituent members, is more easily damaged by external impact. Providing the insulating member 5A on the double-sided negative electrode current collector exposed portion 21A₁ can restrain the exposed portion 21A₁ and can prevent damages by covering the exposed portion 21A₁.

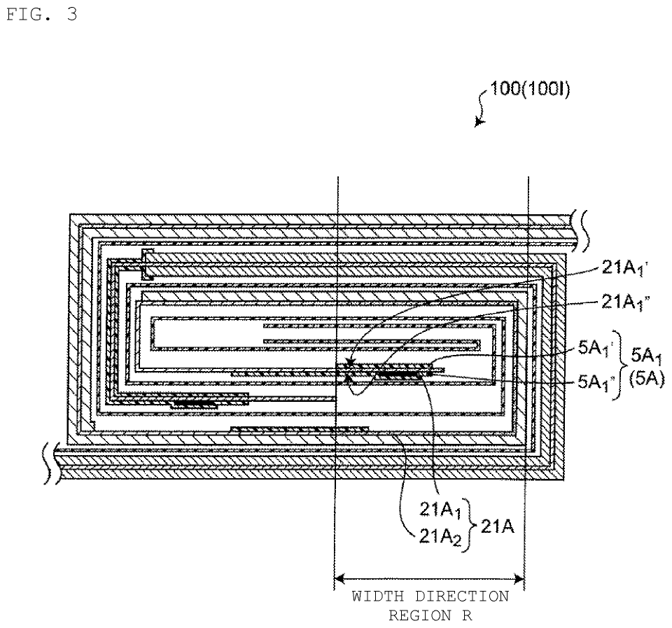

The double-sided negative electrode current collector exposed portion 21A₁ may have a bent shape (see FIG. 2) or does not have to have a bent shape (see FIG. 3). In terms of handleability, the double-sided negative electrode current collector exposed portion 21A₁ preferably has a bent shape. In terms of space saving, it is preferable that the double-sided negative electrode current collector exposed portion 21A₁ does not have a bent shape.

“Bent shape” in the present specification refers to a shape bent from one direction toward a direction opposite to the one direction. The “bent shape” may include a “curved shape” and a “folded shape”. The “Curved shape” refers to bending in a substantially curvilinear manner, leading to rounded bending, and also encompasses flexure. The “folded shape” is to bend substantially linearly.

The insulating member 5A may be provided only on one of the faces 21A₁′ and 21A₁″ of the double-sided negative electrode current collector exposed portion 21A₁, or the insulating member 5A may be provided on both faces. When the viewpoint of further preventing contact between the first negative electrode current collector exposed portion 21A and the positive electrode material layer 12 is emphasized, it is preferable that the insulating member 5A is provided on both faces of the double-sided negative electrode current collector exposed portion 21A₁, that is, the faces 21A₁′ and 21A₁″ (see FIG. 2).

More specifically, the insulating member 5A may be provided in such a manner as to cover 30% or more of the surface area of the double-sided negative electrode current collector exposed portion 21A₁. For example, the insulating member 5A is preferably provided in such a manner as to cover 65% or more or 95% or more of the surface area of the double-sided negative electrode current collector exposed portion 21A₁. When the insulating member is provided in such a manner as to cover 65% or more of the surface area of the double-sided negative electrode current collector exposed portion, a medium-resistance short circuit in the wound electrode body can be more suitably prevented.

From the viewpoint of handleability at the time of manufacturing, the insulating member 5A does not have to be provided at a tip portion of the double-sided negative electrode current collector exposed portion 21A₁. In view of this point, the insulating member 5A may be provided at 98% or less of the surface area of the double-sided negative electrode current collector exposed portion 21A₁.

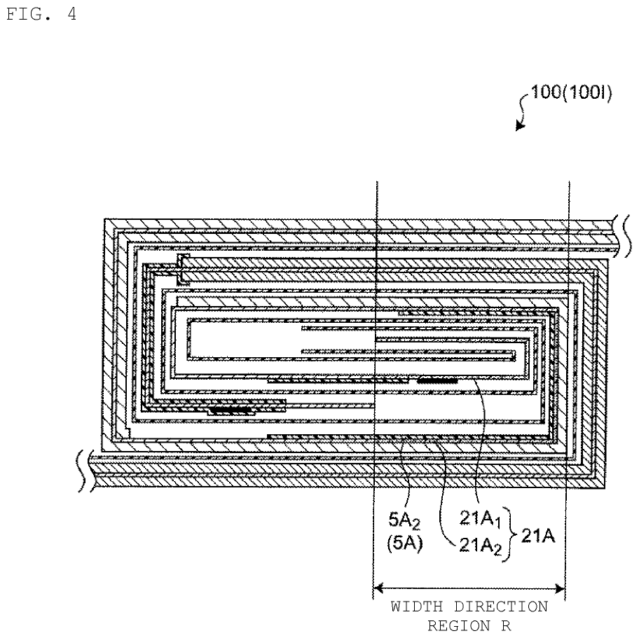

The single-sided negative electrode current collector exposed portion 21A₂ may be positioned in such a manner as to totally surround the double-sided negative electrode current collector exposed portion 21A₁ (see FIG. 4). With the insulating member 5A provided on such a single-sided negative electrode current collector exposed portion 21A₂, the contact between the first negative electrode current collector exposed portion and the positive electrode material layer can be further prevented.

More specifically, the insulating member 5A may be provided in such a manner as to cover 20% or more of the surface area of the single-sided negative electrode current collector exposed portion 21A₂. For example, the insulating member 5A is preferably provided in such a manner as to cover 45% or more or 95% or more of the surface area of the single-sided negative electrode current collector exposed portion 21A₂. When the insulating member is provided in such a manner as to cover 45% or more of the surface area of the single-sided negative electrode current collector exposed portion, a medium-resistance short circuit in the wound electrode body can be more suitably prevented.

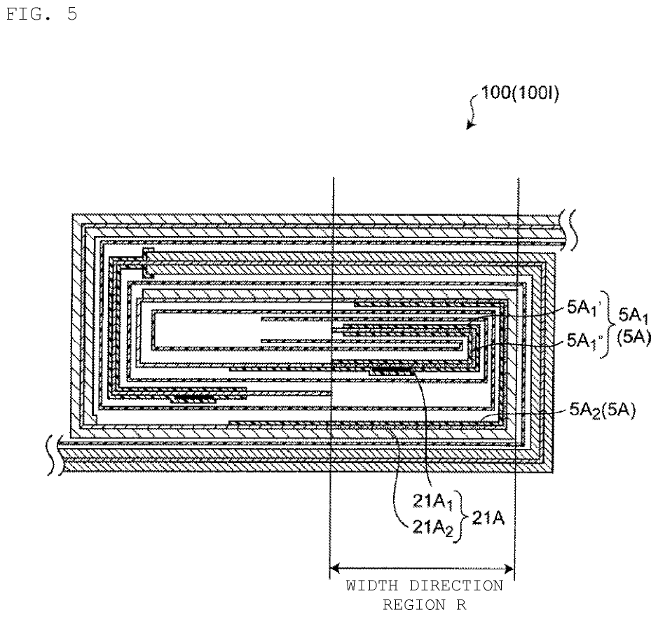

The insulating member 5A may be provided on either one of the double-sided negative electrode current collector exposed portion 21A₁ and the single-sided negative electrode current collector exposed portion 21A₂, or the insulating member 5A may be provided on both of them. From the viewpoint of particularly preventing contact between the first negative electrode current collector exposed portion and the positive electrode material layer, it is preferable that the insulating member 5A is provided on both the double-sided negative electrode current collector exposed portion 21A₁ and the single-sided negative electrode current collector exposed portion 21A₂ (see FIG. 5). In such a case, with respect to the double-sided negative electrode current collector exposed portion 21A₁ and the single-sided negative electrode current collector exposed portion 21A₂ of the wound electrode body, the insulating member 5A may be provided on the double-sided negative electrode current collector exposed portion 21A₁ positioned relatively inside, and at the same time the insulating member 5A may also be provided on the single-sided negative electrode current collector exposed portion 21A₂ positioned relatively outside. As a result, the effect of preventing a medium-resistance short circuit in the wound electrode body can be more remarkable.

More specifically, the insulating member 5A may be provided in such a manner as to cover 40% or more of the surface area of the double-sided negative electrode current collector exposed portion 21A₁ and the single-sided negative electrode current collector exposed portion 21A₂ (that is, the first negative electrode current collector exposed portion 21A). For example, the insulating member 5A is preferably provided in such a manner as to cover 50% or more or 95% or more of the double-sided negative electrode current collector exposed portion 21A₁ and the single-sided negative electrode current collector exposed portion 21A₂. When the insulating member is provided in such a manner as to cover 50% or more of the surface area of the double-sided negative electrode current collector exposed portion and the single-sided negative electrode current collector exposed portion, a medium-resistance short circuit in the wound electrode body can be more suitably prevented.

In one embodiment, the insulating member includes a film substrate and a pressure-sensitive adhesive layer provided on the film substrate. In other words, the insulating member may have the form of a tape. When the insulating member includes the film substrate, high breaking elongation and breaking strength can be imparted to the insulating member. That is, it can suitably contribute to prevention of a medium-resistance short circuit in the wound electrode body. In addition, by including the pressure-sensitive adhesive layer, the insulating member can be more easily provided on the first negative electrode current collector exposed portion, and the handleability at the time of manufacturing can be further enhanced.

In one embodiment, the insulating member contains at least one selected from the group consisting of polyimide, polyethylene terephthalate, and polyvinylidene fluoride. When the insulating member contains such a material, the breaking elongation and the breaking strength can be more excellent. That is, a desired value of the ratio of the breaking elongation of the insulating member to the breaking elongation of the negative electrode current collector is likely to be achieved, and a medium-resistance short circuit in the wound electrode body is easily prevented.

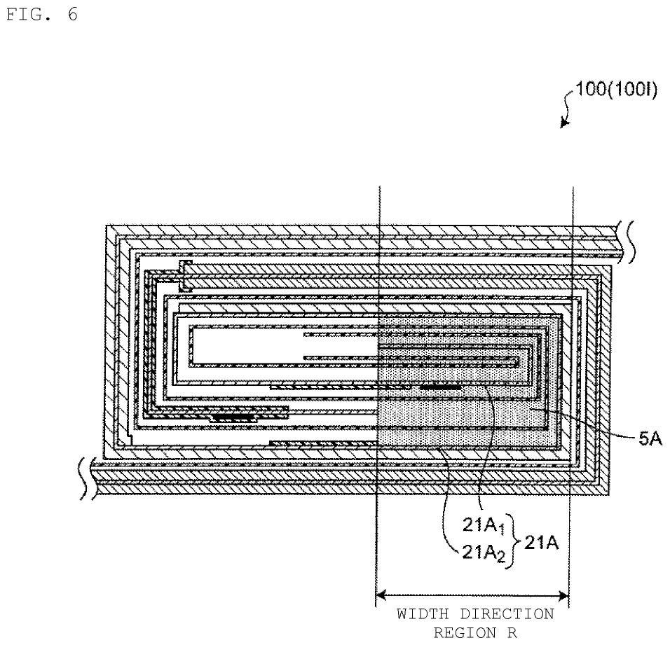

In one embodiment, the first negative electrode current collector exposed portions 21 adhere to each other by an insulating member. That is, the negative electrode current collector exposed portions may be joined to each other by the insulating member. In the exemplary embodiment shown in FIG. 6, the double-sided negative electrode current collector exposed portion 21A₁ and the single-sided negative electrode current collector exposed portion 21A₂ in the first negative electrode current collector exposed portion 21A adhere to each other by the insulating member 5A. It can also be said that the double-sided negative electrode current collector exposed portion 21A₁ and the single-sided negative electrode current collector exposed portion 21A₂ are stuck together by the insulating member 5A with respect to the first negative electrode current collector exposed portion 21A. Although it is merely one example, the first negative electrode current collector exposed portions 21 may be stuck together by using an adhesive as the insulating member 5A.

With the above-described configuration, the first negative electrode current collector exposed portion 21A can be fixed while being covered with the insulating member 5A. That is, in the wound electrode body, the first negative electrode current collector exposed portion 21A can be more suitably and stably disposed. Therefore, when an impact is applied to the secondary battery from the outside, the negative electrode current collector exposed portion can be prevented from moving, and furthermore, the negative electrode current collector exposed portion can be prevented from particularly coming into contact with the positive electrode material layer.

More specifically, 10% or more of the surface areas of the first negative electrode current collector exposed portions 21A may adhere to each other in such a manner as to be covered by the insulating member 5A. For example, it is preferable that 35% or more, 50% or more, or 95% or more of the surface areas of the first negative electrode current collector exposed portions 21A adhere to each other in such a manner as to be covered by the insulating member 5A. When 35% or more of the surface area of the first negative electrode current collector exposed portion is covered with the insulating member as described above, a medium-resistance short circuit in the wound electrode body can be more suitably prevented.

The first negative electrode current collector exposed portions 21A preferably adhere to each other with a peel strength of 15 N/m or more. For example, the first negative electrode current collector exposed portions 21A may adhere to each other with a peel strength of 60 N/m or more or 120 N/m or more.

With the above-described configuration, the peel strength between the first negative electrode current collector exposed portions is higher than the peel strength between the negative electrode material layer and the negative electrode current collector, and the first negative electrode current collector exposed portion covered with the insulating member can be more suitably prevented from being exposed.

The peel strength between the first negative electrode current collector exposed portions adhere to each other by the insulating member may refer to a value measured by a method conforming to JIS standard (JIS Z 0237:2009). For the measurement of the breaking elongation of the insulating member, a TENSILON universal tester (manufactured by A&D Company, Limited/model number RTF2410) may be used.

In one embodiment, in the negative electrode current collector exposed portion, the second negative electrode current collector exposed portion 21B (that is, the negative electrode current collector exposed portion positioned outside the width direction region R) excluding the first negative electrode current collector exposed portion 21A does not have to be provided with the insulating member 5. Alternatively, the insulating member 5 may be provided on the negative electrode current collector exposed portion in such a manner as to cover only a part of the second negative electrode current collector exposed portion 21B. For example, the insulating member 5 may be provided such that the insulating member 5 does not cover the entire second negative electrode current collector exposed portion 21B. For this, see FIG. 2. In the exemplary embodiment of FIG. 2, the insulating member 5 is not continuously present on all sides of the face of the second negative electrode current collector exposed portion 21B. That is, in the second negative electrode current collector exposed portion 21B, the insulating member does not have to be continuously provided in such a manner as to cover the entire folded exposed face or turned-back exposed face which is folded or turned-back due to the winding.

With the above-described configuration, when an impact is applied to the secondary battery from the outside, the second negative electrode current collector exposed portion 21B and the positive electrode current collector 11 (in particular, the positive electrode current collector exposed portion) are preferentially brought into contact with each other, and a low-resistance short circuit can be relatively positively caused. This is likely to lead to prevention of a medium-resistance short circuit due to the first negative electrode current collector exposed portion 21A and can make the secondary battery particularly safe.

The secondary battery according to an embodiment of the present disclosure may be obtained, for example, by a manufacturing method including the steps described below. That is, a method for manufacturing a secondary battery according to the present invention includes the steps of: winding a positive electrode, a negative electrode, and a separator disposed between the positive electrode and the negative electrode to obtain a precursor of a wound electrode body (that is, an assembling step of an electrode body); and housing the wound electrode body in an exterior body and injecting an electrolyte into the exterior body (that is, a housing step).

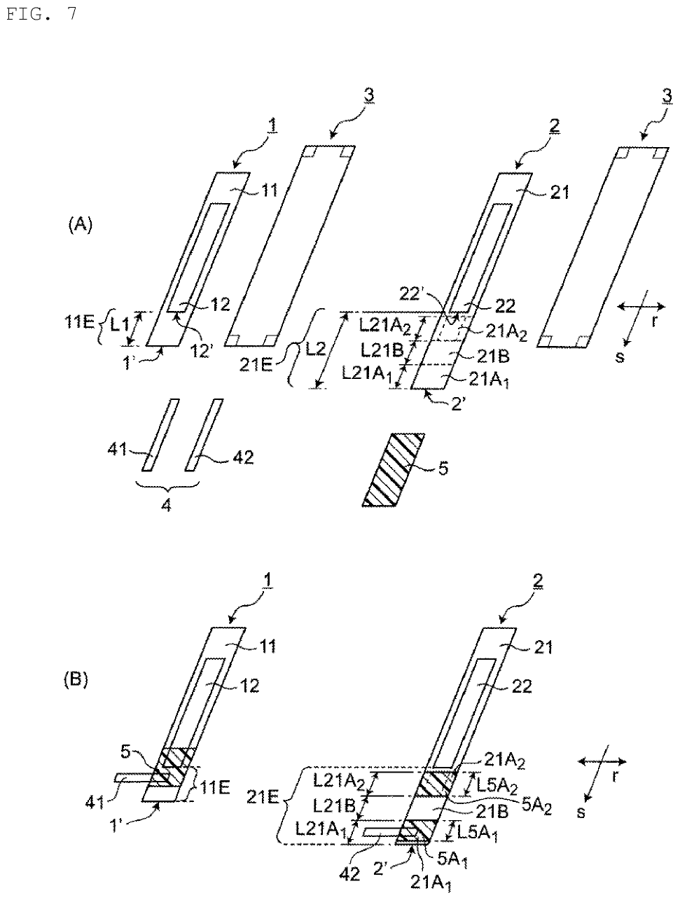

First, the positive electrode 1 and the negative electrode 2 having a desired shape/number, the separator 3 having a rectangular shape, the positive electrode current collecting tab 41 and the negative electrode current collecting tab 42, and the insulating member 5 are prepared (see FIG. 7A). The insulating member 5 may be, as merely an example, a film substrate and a pressure-sensitive adhesive layer provided on the film substrate.

The dimensions of the positive electrode 1 is not particularly limited as long as a precursor of desired electrode body is obtained. The positive electrode 1 has a positive electrode material layer 12 provided on the positive electrode current collector 11 such that a part of the positive electrode current collector 11 is exposed. As an example, in the positive electrode 1, the positive electrode current collector 11 is exposed between a distance L1 between a winding start edge 1′ of the positive electrode and an edge 12′ of the positive electrode material layer. In other words, the positive electrode 1 has the positive electrode current collector exposed portion 11E between the distance L1 between the winding start edge 1′ of the positive electrode and the edge 12′ of the positive electrode material layer. With such a configuration, the handleability can be further enhanced, and the current collecting tab can be more easily attached (see FIG. 7A).

Similarly, the dimensions of the negative electrode 2 are not particularly limited as long as a precursor of desired electrode body is obtained. The negative electrode 2 has a negative electrode material layer 22 provided on the negative electrode current collector 21 such that a part of the negative electrode current collector 21 is exposed. As an example, in the negative electrode 2, the negative electrode current collector 21 is exposed between a distance L2 between a winding start edge 2′ of the negative electrode and an edge 22′ of the negative electrode material layer. In other words, the negative electrode 2 has the negative electrode current collector exposed portion 21E between the distance L2 between the winding start edge 2′ of the negative electrode and the edge 22′ of the negative electrode material layer. With such a configuration, the handleability can be further enhanced, and the current collecting tab can be more easily attached (see FIG. 7A).

From the viewpoint of further enhancing the handleability, the distance L2 between the winding start edge 2′ of the negative electrode and the edge 22′ of the negative electrode material layer may be larger than the distance L1 between the winding start edge 1′ of the positive electrode and the edge 12′ of the positive electrode material layer.

The negative electrode current collector exposed portion 21E may include an exposed portion (that is, the first negative electrode current collector exposed portion) including the double-sided negative electrode current collector exposed portion 21A₁ and the single-sided negative electrode current collector exposed portion 21A₂, and the second negative electrode current collector exposed portion 21B. The double-sided negative electrode current collector exposed portion 21A₁ has a length of L21A₁, the single-sided negative electrode current collector exposed portion 21A₂ has a length of L21A₂, and the second negative electrode current collector exposed portion 21B has a length of L21B in the longitudinal direction s.

The dimensions of the separator 3 are not particularly limited as long as a precursor of desired electrode body is obtained. For example, the length of the separator 3 in the width direction r may be 101% or more and 400% or less, and may be, for example, 102% or more and 120% or less with respect to the length of the positive electrode 1 or the negative electrode 2 in the width direction r (see FIG. 7A).

The length of the separator 3 in the longitudinal direction s may be appropriately determined according to the dimensions of the intended secondary battery (in particular, the number of windings of the electrode body).

Next, in the positive electrode 1, the positive electrode current collecting tab 41 is attached to one face of the positive electrode current collector exposed portion 11E (see FIG. 7B). The attachment method is not limited, and the attachment may be performed by welding in order to ensure stable contact with low resistance. After the positive electrode current collecting tab 41 is attached, one end of the insulating member 5 may be attached in such a manner as to overlap the positive electrode material layer 12.

Next, in the negative electrode 2, the negative electrode current collecting tab 42 is attached to one face of the double-sided negative electrode current collector exposed portion 21A₁ (see FIG. 7B). The attachment method is not limited, and the attachment may be performed by welding in order to ensure stable contact with low resistance. The insulating member 5A₁ may be attached to both faces of the double-sided negative electrode current collector exposed portion 21A₁. Further, in the negative electrode 2, the insulating member 5A₂ may be attached to the face of the single-sided negative electrode current collector exposed portion 21A₂ where the negative electrode material layer 22 is not formed.

When the viewpoint of handleability is emphasized, the insulating members 5 and 5A₁ are preferably attached in such a manner as not to reach the winding start edges 1′ and 2′ of the positive electrode and the negative electrode, respectively.

The insulating member 5A₁ has a length of L5A₁ and the insulating member 5A₂ has a length of L5A₂ in the longitudinal direction s. The ratio of the surface area where the insulating member covers the current collector exposed portion (that is, the coverage of the insulating material) can be adjusted by the ratio between the length L21A₁ of the double-sided negative electrode current collector exposed portion 21A₁ and the length L5A₁ of the insulating member 5A₁ and/or the ratio between the length L21A₂ of the single-sided negative electrode current collector exposed portion 21A₂ and the length L5A₂ of the insulating member 5A₂.

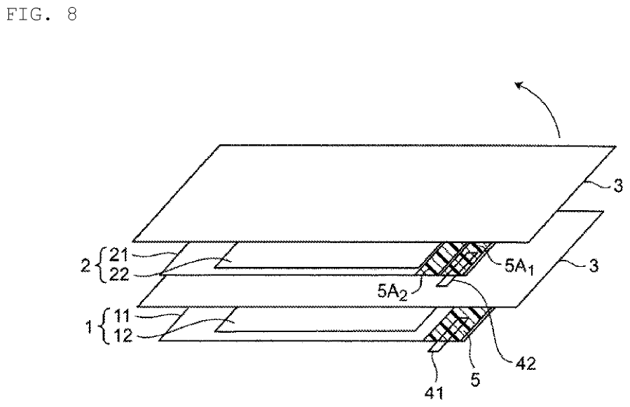

Subsequently, the positive electrode 1, the negative electrode 2, and the two separators 3 having a rectangular shape are arranged in a predetermined order and wound, whereby a precursor of an electrode body can be obtained (see FIG. 8).

The precursor of the electrode body may be formed into a substantially flat column shape by pressing the precursor in the diametrical direction of the wound electrode body as desired.

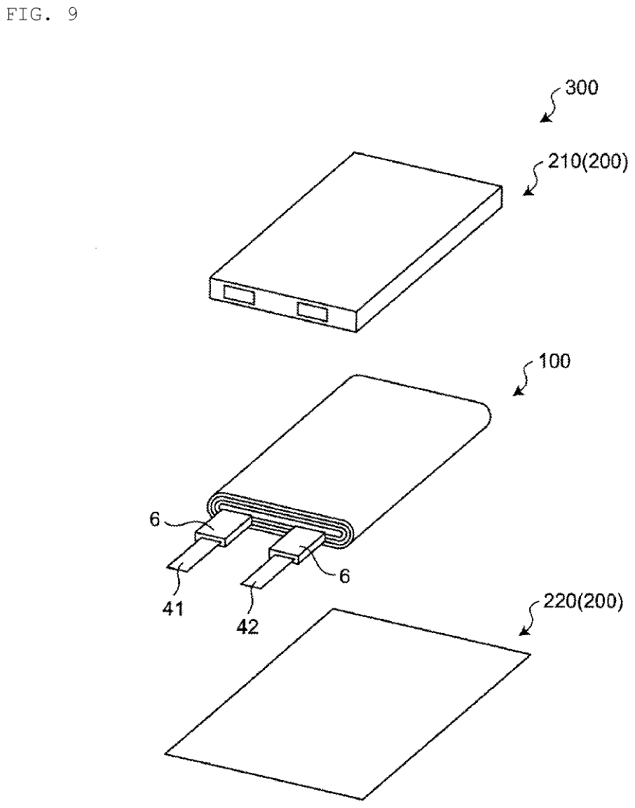

The wound electrode body 100 obtained in the previous step is housed in an exterior body 200 (that is, an exterior body main body portion 210 and exterior body lid portion 220) (see FIG. 9). The current collecting tabs 41 and 42 are led out to the outside through an opening portion formed in the exterior body main body portion 210. The current collecting tabs 41 and 42 may be provided with a close contact member 6 for improving close contact property with the exterior body main body portion 210.

After the wound electrode body 100 is housed, an electrolyte is injected into the exterior body 200. Through the above steps, a desired secondary battery 300 is obtained.

### EXAMPLES

The present disclosure will be described with reference to Examples, but the present disclosure is not limited by these Examples.

### Example 1

A secondary battery particularly having the following characteristics was produced according to the above-described manufacturing method according to an embodiment.
In the wound electrode body 100, the distance L2 between the winding start edge 2′ of the negative electrode and the edge 22′ of the negative electrode material layer in the negative electrode 2 was adjusted (see FIG. 7B) such that the double-sided negative electrode current collector exposed portion 21A₁ has a bent shape (see FIG. 2).
The insulating member 5A₁ was provided in such a manner as to cover at least one face (that is, 21A₁′) of the double-sided negative electrode current collector exposed portion 21A₁ (see FIG. 2). Here, the coverage of the double-sided negative electrode current collector exposed portion 21A₁ was 59.6%.
The insulating member 5A₂ was provided in such a manner as to cover the single-sided negative electrode current collector exposed portion 21A₂.
A copper foil (NC-WS manufactured by Furukawa Electric Co., Ltd.) having a breaking elongation of 5.4% was used as a negative electrode current collector.
Using a 12 μm PET tape (manufactured by Nitto Denko Corporation) having a breaking elongation of 110.0% as an insulating member, the insulating member was attached onto the double-sided negative electrode current collector exposed portion 21A₁. Here, the ratio of the breaking elongation of the insulating member to the breaking elongation of the negative electrode current collector was 20.4.

The electrode was subjected to heat treatment after coating formation, and the value of breaking elongation represents the value after the heat treatment.

### Example 2

A secondary battery was obtained in the same manner as in Example 1 except that the insulating member 5A₁ was provided such that the double-sided negative electrode current collector exposed portion 21A₁ was covered more on both faces (that is, 21A₁′ and 21A₁″). Here, the coverage of the double-sided negative electrode current collector exposed portion 21A₁ was 96.2%.

### Example 3

A secondary battery was obtained in the same manner as in Example 2 except that, as an insulating member, PVDF (manufactured by KUREHA CORPORATION/KF #1300) having a breaking elongation of 280.0% was dissolved in N-methyl-2-pyrrolidone (manufactured by Wako Pure Chemical Industries, Ltd.), and the mixture was applied and dried to form the insulating member on the double-sided negative electrode current collector exposed portion 21A₁. Here, the ratio of the breaking elongation of the insulating member to the breaking elongation of the negative electrode current collector was 51.9.

### Example 4

A secondary battery was obtained in the same manner as in Example 1 except that a PI tape (manufactured by TERAOKA SEISAKUSHO CO., LTD./Kapton pressure-sensitive adhesive tape: 650R #12) having a breaking elongation of 60.0% was used as an insulating member. Here, the ratio of the breaking elongation of the insulating member to the breaking elongation of the negative electrode current collector was 11.1.

### Example 5

A secondary battery was obtained in the same manner as in Example 1 except that both faces of the double-sided negative electrode current collector exposed portion 21A₁ were not covered with an insulating member, and the insulating member 5A₂ was provided in such a manner as to cover the single-sided negative electrode current collector exposed portion 21A₂ (see FIG. 4). Here, the coverage of the single-sided negative electrode current collector exposed portion 21A₂ was 39.3%.

### Example 6

A secondary battery was obtained in the same manner as in Example 5 except that the ratio between the length L21A₂ of the single-sided negative electrode current collector exposed portion 21A₂ and the length L5A₂ of the insulating member 5A₂ was adjusted (see FIG. 7B), and the coverage of the single-sided negative electrode current collector exposed portion 21A₂ was set to 50.0%.

### Example 7

A secondary battery was obtained in the same manner as in Example 5 except that the ratio between the length L21A₂ of the single-sided negative electrode current collector exposed portion 21A₂ and the length L5A₂ of the insulating member 5A₂ was adjusted (see FIG. 7B), and the coverage of the single-sided negative electrode current collector exposed portion 21A₂ was set to 100.0%.

### Example 8

A secondary battery was obtained in the same manner as in Example 2 except that the insulating member 5A₂ was provided in such a manner as to cover the single-sided negative electrode current collector exposed portion 21A₂ at a coverage of 100.0% (see FIG. 5).

### Example 9

A secondary battery was obtained in the same manner as in Example 1 except that the distance L2 between the winding start edge 2′ of the negative electrode and the edge 22′ of the negative electrode material layer in the negative electrode 2 was adjusted (see FIG. 7B) such that the double-sided negative electrode current collector exposed portion 21A₁ did not have a bent shape in the wound electrode body 100 (see FIG. 3). Here, the coverage of the double-sided negative electrode current collector exposed portion 21A₁ was 63.2%.

### Example 10

A secondary battery was obtained in the same manner as in Example 9 except that the insulating member 5A₁ was provided such that the double-sided negative electrode current collector exposed portion 21A₁ was covered more on both faces (that is, 21A₁′ and 21A₁″). Here, the coverage of the double-sided negative electrode current collector exposed portion 21A₁ was 89.5%.

### Example 11

A secondary battery was obtained in the same manner as in Example 1 except that an acrylic adhesive (TB3955 manufactured by ThreeBond Co., Ltd.) having a breaking elongation of 250.0% was formed as an insulating member in such a manner as to cover the first negative electrode current collector exposed portions 21A by coating, thereafter the first negative electrode current collector exposed portions 21A (that is, 21A₁ and 21A₂) adhered to each other (see FIG. 6). Here, the coverage of the double-sided negative electrode current collector exposed portion 21A₁ and the single-sided negative electrode current collector exposed portion 21A₂ was 35.0%.

### Example 12

A secondary battery was obtained in the same manner as in Example 11 except that the ratio between the lengths L21A₁ and L21A₂ of the double-sided negative electrode current collector exposed portion 21A₁ and the single-sided negative electrode current collector exposed portion 21A₂ and the lengths L5A₁ and L5A₂ of the insulating members 5A₁ and 5A₂ was adjusted (see FIG. 7B), and the coverage of the double-sided negative electrode current collector exposed portion 21A₁ and the single-sided negative electrode current collector exposed portion 21A₂ was set to 100.0%.

### Comparative Example 1

A secondary battery was obtained in the same manner as in Example 1 except that an insulating member was provided on the negative electrode current collector exposed portion in such a manner as to be positioned between the positive electrode current collector exposed portion and the negative electrode current collector exposed portion and as not to cover the first negative electrode current collector exposed portion.

### Comparative Example 2

A secondary battery was obtained in the same manner as in Comparative Example 1 except that the distance L2 between the winding start edge 2′ of the negative electrode and the edge 22′ of the negative electrode material layer in the negative electrode 2 was adjusted (see FIG. 7B) such that the double-sided negative electrode current collector exposed portion 21A₁ did not have a bent shape in the wound electrode body 100 (see FIG. 3).

### Comparative Example 3

A secondary battery was obtained in the same manner as in Example 1 except that, as an insulating member, PMMA (manufactured by Mitsubishi Chemical Corporation/Acrypet MF) having a breaking elongation of 7.0% was dissolved in tetrahydrofuran (manufactured by Wako Pure Chemical Industries, Ltd.), and the mixture was applied and dried to form the insulating member on the double-sided negative electrode current collector exposed portion 21A₁. Here, the ratio of the breaking elongation of the insulating member to the breaking elongation of the negative electrode current collector was 1.3.

### Comparative Example 4

A secondary battery was obtained in the same manner as in Example 11 except that the ratio between the length L21A₁ and L21A₂ of the double-sided negative electrode current collector exposed portion 21A₁ and the single-sided negative electrode current collector exposed portion 21A₂ and the lengths L5A₁ and L5A₂ of the insulating members 5A₁ and 5A₂ was adjusted (see FIG. 7B), and the coverage of the double-sided negative electrode current collector exposed portion 21A₁ and the single-sided negative electrode current collector exposed portion 21A₂ was set to 5.0%.

The secondary battery samples of Examples and Comparative Examples produced as described above were subjected to a safety test according to the following method.

### [Details of Safety Test]

(Impact Test)

The presence or absence of an internal short circuit due to impact was evaluated by a method conforming to the UL 1642 standard. Specifically, a round bar having a diameter of 15.8 mm was placed on a flat portion of the secondary battery sample arranged in parallel on a support, a weight of 9.1 kg was dropped on the round bar from a height of 61 cm, and whether or not the secondary battery was ignited (or burnt) was checked.

For each secondary battery sample, (1) a battery that was CCCV charged (CC charging current 0.5 C, cutoff current 0.02 C) at an upper limit voltage of 4.4 V in a thermostatic bath at 20° C. and then stored in the thermostatic bath for 10 minutes or more, and (2) a battery that was CCCV charged (CC charging current 0.5 C, cutoff current 0.02 C) at an upper limit voltage of 4.5 V in a thermostatic bath at 45° C. and then stored in the thermostatic bath for 10 minutes or more were each taken out from the thermostatic bath and immediately subjected to the impact test.

(Impact Test Result)

For the presence or absence of an internal short circuit in each secondary battery sample, the results in (1) charging at 20° C. and 4.4 V and (2) charging at 45° C. and 4.5 V were evaluated according to the following criteria.

∘: no part of the battery was ignited (or burnt).

Δ: only a part of the battery was ignited (or burnt).

x: the entire battery was ignited.

(Overall Evaluation)

The presence or absence of an internal short circuit in each secondary battery sample was comprehensively evaluated according to the following criteria.

S: both (1) charging at 20° C. and 4.4 V and (2) charging at 45° C. and 4.5 V were 0.

A: (1) charging at 20° C. and 4.4 V was 0, and (2) charging at 45° C. and 4.5 V was A.

B: (1) charging at 20° C. and 4.4 V was 0, and (2) charging at 45° C. and 4.5 V was x.

C: (1) charging at 20° C. and 4.4 V was A, and (2) charging at 45° C. and 4.5 V was x.

D: both (1) charging at 20° C. and 4.4 V and (2) charging at 45° C. and 4.5 V were x.

Details and evaluation results of each secondary battery sample are shown in Table 1 for Examples 1 to 10 and Comparative Examples 1 to 3, and in Table 2 for Examples 11 and 12 and Comparative Example 4.

As shown in Tables 1 and 2, it was found that all the Example samples in which the insulating member was provided in such a manner as to cover the first negative electrode current collector exposed portion, and the insulating member had a relatively larger breaking elongation than that of the negative electrode current collector had good “safety against impact test”.

In addition, it was found that the larger the coverage of the insulating member to the first negative electrode current collector exposed portion and/or the larger the ratio of the breaking elongation of the insulating member to the breaking elongation of the negative electrode current collector, the better “safety against the impact test”.

TABLE 1

| | | Covering condition | | | | | | | | | |
|---|---|---|---|---|---|---|---|---|---|---|---|
| | | Coverage | Coverage | | | | | | | | |
| | | of | of | Coverage | | | | | | | |
| | | double- | single- | of | | | | Breaking | | | |
| | | sided | sided | first | Breaking | | | elongation | | | |
| | | negative | negative | negative | elongation | | | ratio | Impact test result | | |
| | | electrode | electrode | electrode | of | | Breaking | (insulating | (1) | (2) | |
| | | current | current | current | negative | | elongation | member/ | Charging | Charging | |
| | | collector | collector | collector | electrode | | of | negative | at | at | |
| | Electrode | exposed | exposed | exposed | current | | insulating | electrode | 20° C. | 45° C. | |
| | body | portion | portion | portion | collector | Insulating | member | current | and 4.4 | and 4.5 | Overall |
| | structure | (%) | (%) | (%) | (%) | member | (%) | collector) | V | V | evaluation |
| Example 1 | FIG. 2 | 59.6 | 17.9 | 45.0 | 5.4 | PET tape | 110.0 | 20.4 | ∘ | x | B |
| Example 2 | FIG. 2 | 96.2 | 17.9 | 68.8 | 5.4 | PET tape | 110.0 | 20.4 | ∘ | Δ | A |
| | | | | | | PVDF | | | | | |
| Example 3 | FIG. 2 | 96.2 | 17.9 | 68.8 | 5.4 | application | 280.0 | 51.9 | ∘ | ∘ | S |
| Example 4 | FIG. 2 | 59.6 | 17.9 | 45.0 | 5.4 | PI tape | 60.0 | 11.1 | Δ | x | C |
| Example 5 | FIG. 4 | 28.8 | 39.3 | 32.5 | 5.4 | PET tape | 110.0 | 20.4 | Δ | x | C |
| Example 6 | FIG. 4 | 28.8 | 50.0 | 36.3 | 5.4 | PET tape | 110.0 | 20.4 | ∘ | x | B |
| Example 7 | FIG. 4 | 28.8 | 100.0 | 53.8 | 5.4 | PET tape | 110.0 | 20.4 | ∘ | Δ | A |
| Example 8 | FIG. 5 | 96.2 | 100.0 | 97.5 | 5.4 | PET tape | 110.0 | 20.4 | ∘ | ∘ | S |
| Example 9 | FIG. 3 | 63.2 | 17.9 | 36.2 | 5.4 | PET tape | 110.0 | 20.4 | ∘ | x | C |
| Example 10 | FIG. 3 | 89.5 | 17.9 | 46.8 | 5.4 | PET tape | 110.0 | 20.4 | ∘ | Δ | B |
| Comparative | FIG. 2 | 28.8 | 17.9 | 25.0 | 5.4 | PET tape | 110.0 | 20.4 | x | x | D |
| Example 1 | | | | | | | | | | | |
| Comparative | FIG. 3 | 44.7 | 17.9 | 28.7 | 5.4 | PET tape | 110.0 | 20.4 | x | x | D |
| Example 2 | | | | | | | | | | | |
| Comparative | FIG. 2 | 59.6 | 17.9 | 45.0 | 5.4 | PMMA | 7.0 | 1.3 | x | x | D |
| Example 3 | | | | | | application | | | | | |

TABLE 2

| | | Covering condition | | | | | | | | |
|---|---|---|---|---|---|---|---|---|---|---|
| | | Coverage | | | | Breaking | | | | |
| | | of first | | | | elongation | | | | |
| | | negative | Breaking | | | ratio | | | | |
| | | electrode | elongation | | | (insulating | | | | |
| | | current | of negative | | Breaking | member/ | | Impact test result | | |
| | | collector | electrode | | elongation | negative | | (1) | (2) | |
| | Electrode | exposed | current | | of | electrode | Peel | Charging | Charging | |
| | body | portion | collector | Insulating | insulating | current | strength | at 20° C. | at 45° C. | Overall |
| | structure | (%) | (%) | member | member (%) | collector) | (N/m) | and 4.4 V | and 4.5 V | evaluation |
| Example 11 | FIG. 6 | 35.0 | 5.4 | Acrylic | 250.0 | 46.3 | >120 | ∘ | x | B |
| | | | | adhesive | | | | | | |
| Example 12 | FIG. 6 | 100.0 | 5.4 | Acrylic | 250.0 | 46.3 | >120 | ∘ | ∘ | S |
| | | | | adhesive | | | | | | |
| Comparative | FIG. 6 | 5.0 | 5.4 | Acrylic | 250.0 | 46.3 | >120 | x | x | D |
| Example 4 | | | | adhesive | | | | | | |

From the safety test and the evaluation results thereof, it was found that the secondary battery according to an embodiment of the present disclosure can be more suitable in terms of prevention of a short circuit, in particular, prevention of a medium-resistance short circuit.

While various embodiments of the present technology have been described above, the present disclosure is not limited thereto, and various other embodiments of the present technology are conceivable without changing the scope of the present disclosure.

For example, because the first negative electrode current collector exposed portion 21A is particularly located at the inner peripheral portion of the wound electrode body, the insulating member 5A may be for example provided in such a manner as to straddle the negative electrode current collecting tab 42 in a sectional view (see FIG. 2) according to an embodiment of the present disclosure.

The secondary battery according to an embodiment of the present disclosure may be used in various fields where power storage is assumed. For example, the secondary battery may be used in the fields of electricity, information, and communication in which electricity, electronic equipment, and the like are used (for example, electric and electronic equipment fields or mobile equipment fields including mobile phones, smartphones, notebook computers, digital cameras, activity meters, arm computers, electronic paper, wearable devices, RFID tags, card-type electronic money, and smartwatches), home and small industrial applications (for example, the fields of electric tools, golf carts, and home, nursing, and industrial robots), large industrial applications (for example, fields of forklift, elevator, and harbor crane), transportation system fields (for example, the fields of hybrid vehicles, electric vehicles, buses, trains, power-assisted bicycles, electric two-wheeled vehicles, and the like), power system applications (for example, the fields of various types of power generation, road conditioners, smart grids, and household power storage systems), medical applications (medical equipment fields such as hearing aid earbuds), pharmaceutical applications (fields such as dosage management systems), IoT fields, space and deep sea applications (for example, fields such as a space probe and a submersible), and the like.

The secondary battery according to an embodiment the present technology can prevent a short circuit that may occur particularly when an impact is applied to the battery. In this regard, for example, the secondary battery according to the present technology can be preferably used for mobile device applications and the like that tend to receive impact more frequently.

### DESCRIPTION OF REFERENCE SYMBOLS

1: Positive electrode
11: Positive electrode current collector
11E: Positive electrode current collector exposed portion
12: Positive electrode material layer
2: Negative electrode
21: Negative electrode current collector
21E: Negative electrode current collector exposed portion
21A: First negative electrode current collector exposed portion
21A₁: Double-sided negative electrode current collector exposed portion
21A₂: Single-sided negative electrode current collector exposed portion
21B: Second negative electrode current collector exposed portion
22: Negative electrode material layer
3: Separator
4: Current collecting tab
41: Positive electrode current collecting tab
42: Negative electrode current collecting tab
5: Insulating member
6: Close contact member
100: Wound electrode body
1001: Inner peripheral portion of wound electrode body
200: Exterior body
210: Exterior body main body portion
220: Exterior body lid portion
300: Secondary battery

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a wound electrode body in which a positive electrode and a negative electrode are wound with a separator interposed between the positive electrode and the negative electrode,
wherein
the positive electrode includes a positive electrode current collector and a positive electrode material layer provided on the positive electrode current collector in such a manner as to form a positive electrode current collector exposed portion where a part of the positive electrode current collector is exposed, and the negative electrode includes a negative electrode current collector and a negative electrode material layer provided on the negative electrode current collector in such a manner as to form a negative electrode current collector exposed portion where a part of the negative electrode current collector is exposed,
in a sectional view of the wound electrode body, the negative electrode current collector exposed portion includes at least one first negative electrode current collector exposed portion facing the positive electrode material layer in the positive electrode that is adjacent on both sides in a thickness direction of the wound electrode body,
an insulating member is provided in such a manner as to cover the first negative electrode current collector exposed portion, and
the insulating member has a breaking elongation larger than a breaking elongation of the negative electrode current collector.

2. The secondary battery according to claim 1, wherein in the sectional view, the insulating member has a folded or turned-back continuous form in such a manner as to cover the first negative electrode current collector exposed portion that is folded or turned back.

3. The secondary battery according to claim 2, wherein
the first negative electrode current collector exposed portion includes a double-sided negative electrode current collector exposed portion in which both faces of the negative electrode current collector are exposed, and a single-sided negative electrode current collector exposed portion in which one face of the negative electrode current collector is exposed, and
one or both of the double-sided negative electrode current collector exposed portion and the single-sided negative electrode current collector exposed portion is provided with the insulating member.

4. The secondary battery according to claim 3, wherein the insulating member is provided in such a manner as to cover 65% or more of a surface area of the double-sided negative electrode current collector exposed portion.

5. The secondary battery according to claim 4, wherein the insulating member is provided in such a manner as to cover 45% or more of a surface area of the single-sided negative electrode current collector exposed portion.

6. The secondary battery according to claim 2, wherein with respect to the double-sided negative electrode current collector exposed portion and the single-sided negative electrode current collector exposed portion, the insulating member is provided on the double-sided negative electrode current collector exposed portion positioned inside, and the insulating member is also provided on the single-sided negative electrode current collector exposed portion positioned outside.

7. The secondary battery according to claim 3, wherein the insulating member is provided in such a manner as to cover 50% or more of a surface area of the double-sided negative electrode current collector exposed portion and a surface area of the single-sided negative electrode current collector exposed portion.

8. The secondary battery according to claim 1, wherein a ratio of the breaking elongation of the insulating member to the breaking elongation of the negative electrode current collector is 20 or more.

9. The secondary battery according to claim 1, wherein the breaking elongation of the insulating member is 100% or more.

10. The secondary battery according to claim 1, wherein the insulating member includes a film substrate and a pressure-sensitive adhesive layer provided on the film substrate.

11. The secondary battery according to claim 1, wherein the insulating member contains at least one selected from the group consisting of polyimide, polyethylene terephthalate, and polyvinylidene fluoride.

12. The secondary battery according to claim 1, wherein the first negative electrode current collector exposed portion includes a plurality of first negative electrode current collector portions adhere to each other by the insulating member.

13. The secondary battery according to claim 12, wherein the first negative electrode current collector exposed portions adhere to each other such that 35% or more of a surface area of the first negative electrode current collector exposed portions is covered with the insulating member.

14. The secondary battery according to claim 13, wherein the first negative electrode current collector exposed portions adhere to each other with a peel strength of 15 N/m or more.

15. The secondary battery according to claim 1, wherein the insulating member is not provided in a second negative electrode current collector exposed portion of the negative electrode current collector exposed portion excluding the first negative electrode current collector exposed portion, or the insulating member is provided in the negative electrode current collector exposed portion in such a manner as to cover a part of the second negative electrode current collector exposed portion.

16. The secondary battery according to claim 1, wherein the positive electrode and the negative electrode are capable of occluding and releasing lithium ions.

17. The secondary battery according to claim 1, wherein
the first negative electrode current collector exposed portion includes a double-sided negative electrode current collector exposed portion in which both faces of the negative electrode current collector are exposed, and a single-sided negative electrode current collector exposed portion in which one face of the negative electrode current collector is exposed, and
one or both of the double-sided negative electrode current collector exposed portion and the single-sided negative electrode current collector exposed portion is provided with the insulating member.

18. The secondary battery according to claim 3, wherein the insulating member is provided in such a manner as to cover 45% or more of a surface area of the single-sided negative electrode current collector exposed portion.

19. The secondary battery according to claim 12, wherein the first negative electrode current collector exposed portions adhere to each other with a peel strength of 15 N/m or more.
